(19) United States
(12) Patent Application Publication
(10) Pub. No.: US 2017/0258270 A1
(43) Pub. Date: Sep. 14, 2017

(54) OIL FILTER DEEP FRYER

(71) Applicant: NINGBO BIYI ELECTRIC APPLIANCE CO., LTD, Zhejiang (CN)

(72) Inventor: Kaimong MAN, Zhejiang (CN)

(73) Assignee: NINGBO BIYI ELECTRIC APPLIANCE CO., LTD, Zhejiang (CN)

(21) Appl. No.: 15/188,471

(22) Filed: Jun. 21, 2016

(30) Foreign Application Priority Data
Mar. 9, 2016 (CN) 201610132549.5

(51) Int. Cl. A47J 37/12

(52) U.S. Cl. CPC A47J 37/1223; A47J 37/1209; A47J 37/128; A47J 37/1295; A47J 37/1261; A47J 37/1266

(57) ABSTRACT

An oil filter deep fryer is designed for the technical issues of unsatisfactory structural design of the existing like products. The oil filter deep fryer comprises a housing, lid, control box, heating tube, inner pot, oil receiver and food basket. The deep fryer enables the oil receiver to pull out or lock in the housing and drain the waste oil into the oil receiver through a knob.

### FIELD OF TECHNOLOGY

The present invention relates to a deep fryer, or specifically an oil filter deep fryer.

### BACKGROUND OF THE INVENTION

Deep fryer is an electric appliance for frying of various meat, vegetables, doughnuts, fruits and other food using a conventional home appliance, which is easy to operate, with fast heating, is a special drying device for fast food store and home. The oil filtering structure of some existing fryers has been modified for the convenience of waste oil collection, e.g.: China Patent Document Application No. 201020211263.4, Date of Patent: Mar. 16, 2011, New Utility Name: “Deep fryer with the filtration and adsorption structure”; this deep fryer comprises the housing, the base under the housing, the inner pot disposed in the housing, the lid covering the inner pot and deep frying components, which also includes the filtration adsorber, a mounting hole is provided at the bottom part of inner pot, the filtration adsorber is disposed in the mounting hole; the oil valve is provided in the lower part of the filtration adsorber, the oil receiving disc is provided below the oil valve; the filtration adsorber is a tubular member which has the filtration element and adsorption element. Although the filtration and absorption structure of the said deep fryer uses the rocker structure, the safety level of its oil receiving disc remains to be further enhanced, and the assembly, mounting, positioning and oil filter structure of the filtration adsorber remain to be further improved.

### SUMMARY OF THE INVENTION

To overcome the said shortcomings, the purpose of the present invention is to provide an oil filter deep fryer that resolves the technical problems identified in like products, e.g.: structural design is bad, the safety level and oil filter structure remain to be further improved. This purpose is achieved by the following technical solutions.

An oil filter deep fryer comprising a housing, lid, control box, heating tube, inner pot, oil receiver and food basket, the said lid is provided with a transparent plate, breathable plate and handle, an inner pot is provided in the housing, a base is provided in the housing at the bottom of inner pot, an oil receiver is provided in the base, a rocker is provided at the oil inlet opening of oil receiver, one end of rocker passes through the oil inlet of the plug sealed oil receiver, its other end interacts with the knob, the pivot between two ends is mounted on the oil receiver which comprises a framework and cover; the said rocker of oil inlet has an oil drain assembly on the upper part, the ejector rob of drain assembly interacts with the end of rocker which is provided with the oil filter opening, the ejector rob of drain assembly interacts with the end of rocker which is provided with the oil filter opening, the drain assembly is mounted at the oil drain of inner pot, the oil drain assembly at the oil drain is provided with a filter screen, the heating tube is linked with the control box as an entity, the heating tube is L-shaped, when the control box is placed in the groove of housing, the heating tube is located at the inner bottom of inner pot; thus, such deep fryer enables the oil drain assembly to open or close through the rocker swinging and the ejector rod, and collects the waste oil from the inner pot to the oil receiver. Where the said knob is provided at the upper part of oil receiver outlet in the base of housing, the cover plate and limit slot are provided at the knob end of oil receiver, the cover plate is linked with the oil receiver as an entity, the limit lug and the rocker lug are provided at the knob end of oil receiver in the housing, the limit lug of knob is staggeringly and adjacently arranged to the rocker lug of knob in front and back position, the limit lug and the rocker lug of knob are located in the housing, the limit lug of knob is inserted into the limit slot of oil receiver, and the rocker lug of knob interacts with the rocker. When the knob is turned to open, the limit lug of knob and the limit slot of oil receiver detaches, the oil receiver is pulled out of the housing through the cover plate; when the knob is turned to close, the limit lug of knob inserts into the limit slot of oil receiver, but the oil receiver cannot be pulled out of the housing; when the knob is turned to oil draining, the rocker lug of knob interacts with the rocker which drives the ejector rod of oil drain assembly to lift upwardly, the oil inlet opening of inner pot is opened, and the waste oil will flow into the oil receiver through the oil inlet opening, the oil drain assembly and the oil filter opening of rocker from the inner pot.

The limit lug of the said knob is a big lug with an included angle of 60°, and the end angle of rocker lug connecting to one end of limit lug has a guide curved edge. The shape and size of limit lug and rocker lug of the said knob are primarily used to suit the travel requirements of the said knob in opening, closing and oil draining.

The ejector rob of the said oil drain assembly is screw-shaped, one end of the ejector rob passes through the spring, the nut seat sequentially to connect with the valve in the nut, the valve is T-shaped and limited to the inner diameter of the nut orifice, the outer diameter of the valve is provided with a seal plug, the nut and the nut seat are connected and mounted at the oil drain opening of inner pot through the internal and external threads, and a sealing ring is provided at the joint. Subject to the force, the knob end of rocker drives the raising of oil drain end, driving the upward movement of ejector rod in the nut seat, and the ejector rod drives the upward lifting of valve at the nut to open the nut orifice; the knob end of rocker is relieved from the force, when the rocker, ejector rod and valve are reset and the nut orifice is closed.

The oil drain of inner pot has a bracket, which interacts with the oil receiver, the nut seat of oil drain assembly is fit into the bracket, and is V-shaped. The said bracket prevents the inner pot from sinking, which can be also used to further mount and locate the oil drain assembly.

The oil drain assembly of the said rocker has a circular groove and the oil filter is provided at the knob end in the circular groove. The said structure further ensures that the waste oil from oil drain assembly flow into the oil receiver.

The bottom of the knob end of the said rocker has a compression spring that is disposed in the compression spring slot of oil receiver. The compression spring is used to reset the rocker and further improve the sealing between the upper plug of rocker and the oil inlet opening of oil receiver.

The said food basket comprises big food basket and small food baskets, both the big food basket and small food baskets are provided with handles, and the handle end of the inner rim of the big basket or small baskets is provided with the raised limit steel wire which is linked with the basket framework steel wire connecting to the handle as an entity, and two small food baskets are horizontally disposed in the big food basket side by side. The said structure has small food baskets fit into the big food basket, facilitating the use of the corresponding food basket depending on different food; meanwhile, the fitting between the big food basket and small food baskets is limited using limit steel wire.

The raised conductive grooves are symmetrically disposed at the heating tube end of the said control box, its one end is L-shaped outwardly, an arched spring piece is provided in the conductive groove at one L-shaped end, the insertion slot is provided in the box groove in the housing corresponding to the spring piece, and the conducting piece is provided in the insertion slot corresponding to the spring piece. Thus, when the control box and the housing are latched, the circuit in deep fryer is automatically connected.

The control panel of the said control box has an oil replacement indicator. The oil replacement indicator can timely alert the user to filter the oil in the inner pot, according to the number of heating, time of heating or oil quality; exactly speaking, when the oil in the inner pot is used for a long time, the number of heating is excessive, or the oil quality is detected to be faulty, the oil replacement indicator will notify the user to filter the oil and send out instructions depending on the time, number of heating or the automatic detection data of oil in the setting of circuit board, and the indicator is lit.

The present invention has a reasonable structural design, which is easy to produce, use and clean, with good safety of application, good sealing and safety for the collection of waste oil; it is mainly used as the deep fryer enabling the function of collecting waste oil, modifying the structure of like products.

### BRIEF INTRODUCTION OF THE DRAWINGS

FIG. 1 is an explosive view of the structure of the invention.

FIG. 2 is a 3D schematic view of the invention.

FIG. 3 is a sectional view of the invention where Part A is marked.

FIG. 4 is an enlarged view of Part A of FIG. 3.

FIG. 5 shows the oil draining state of FIG. 4 in which the arrow indicates the direction of oil filtration.

FIG. 6 shows the internal structure of the housing of FIG. 2 in which the filter screen is omitted.

FIG. 7 is the first part-schematic diagram of the oil receiver of the invention.

FIG. 8 is the second part-schematic diagram of the oil receiver of the invention.

FIG. 9 shows a 3D structure of the knob of the invention.

FIG. 10 is a side view of the knob of the invention.

FIG. 11 is a part-schematic diagram of the oil drain assembly of the invention.

FIG. 12 is an explosive view of the structure of FIG. 11 in which the oil filter is omitted.

Drawing No. and name: 1. Housing; 2. Lid; 3. Knob; 301. Limit lug; 302. Rocker lug; 4. Big food basket; 5. Small food baskets; 6. Cover; 7. Control box; 701. Oil replacement indicator; 8. Heating tube; 9. Oil drain assembly; 901. Ejector rod; 902. Spring; 903. Nut seat; 904. Seal ring; 905. Nut; 906. Seal plug; 907. Valve; 10. Filter screen; 11. Inner pot; 12. Rocker; 1201. Oil filter opening; 13. Compression spring; 14. Plug; 15. Bracket; 16. Oil receiver

### DESCRIPTION OF THE EMBODIMENT

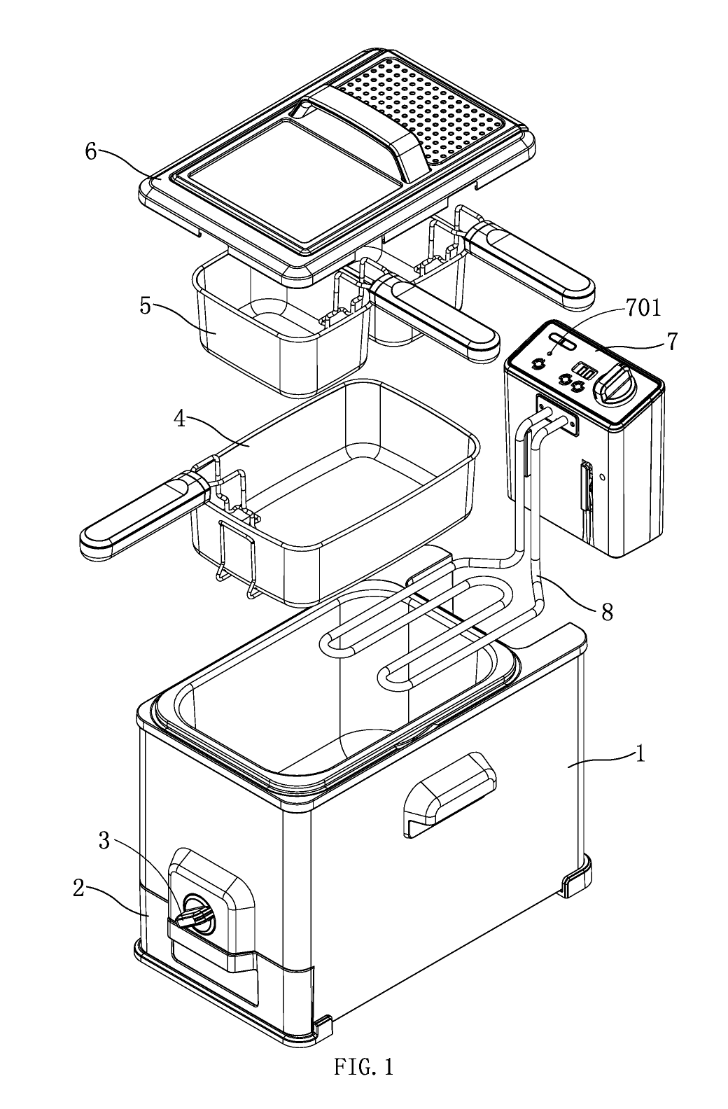

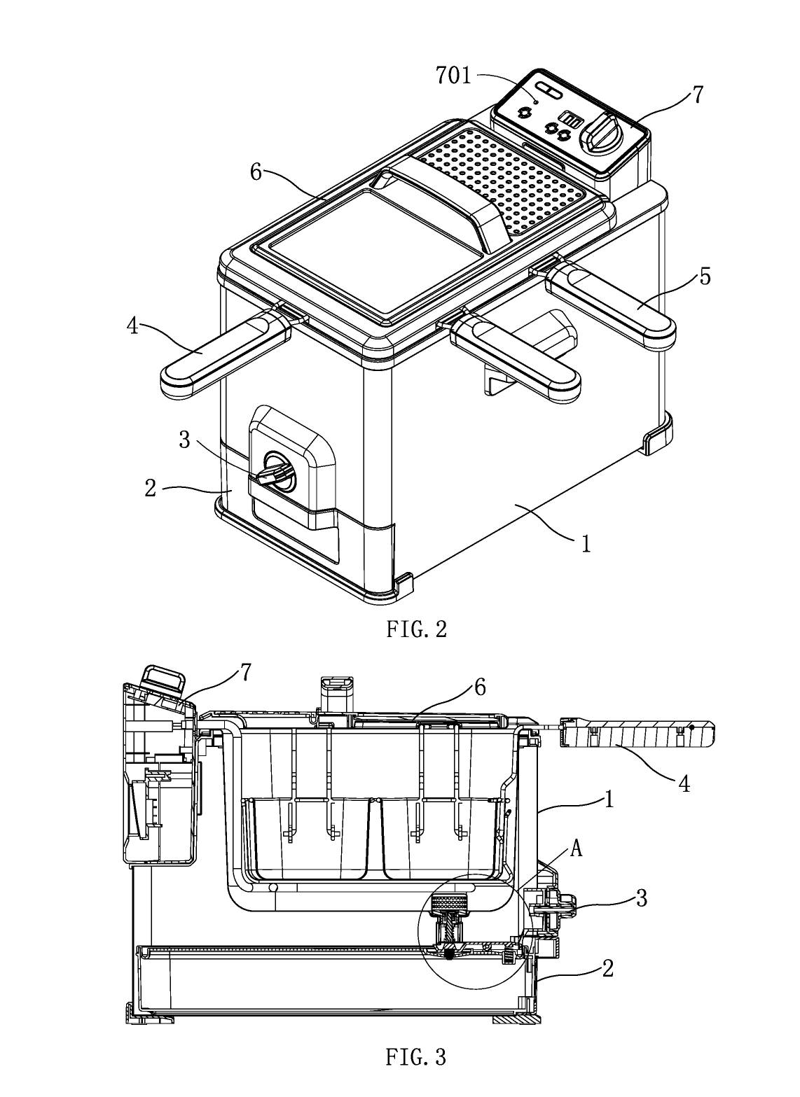

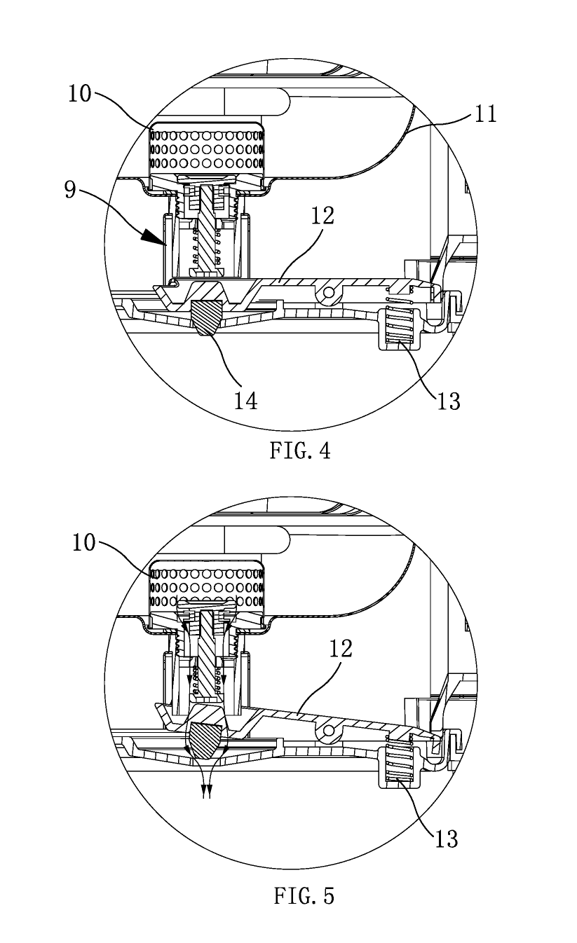

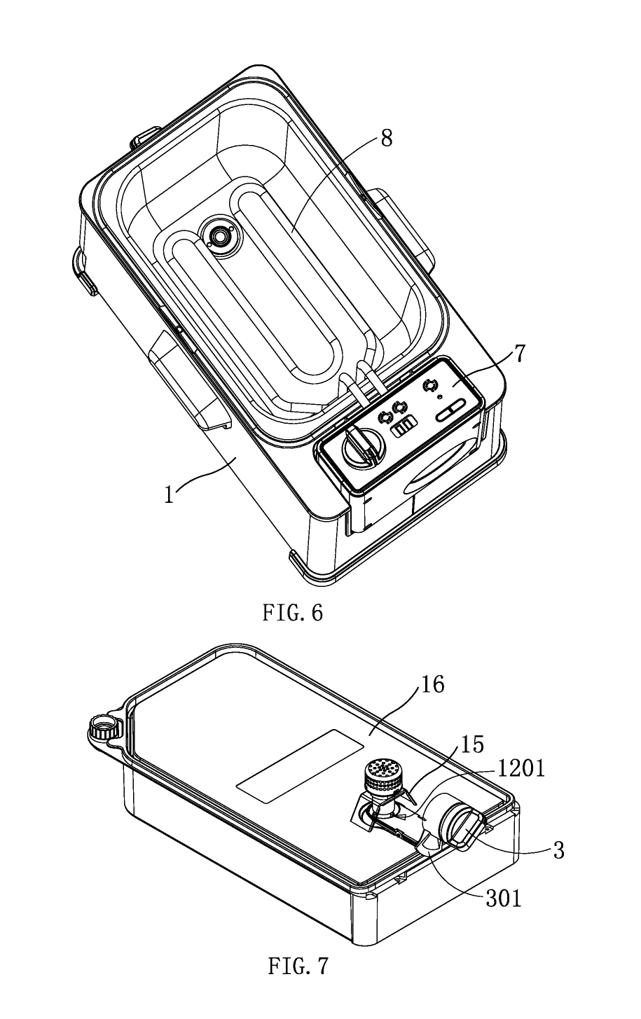

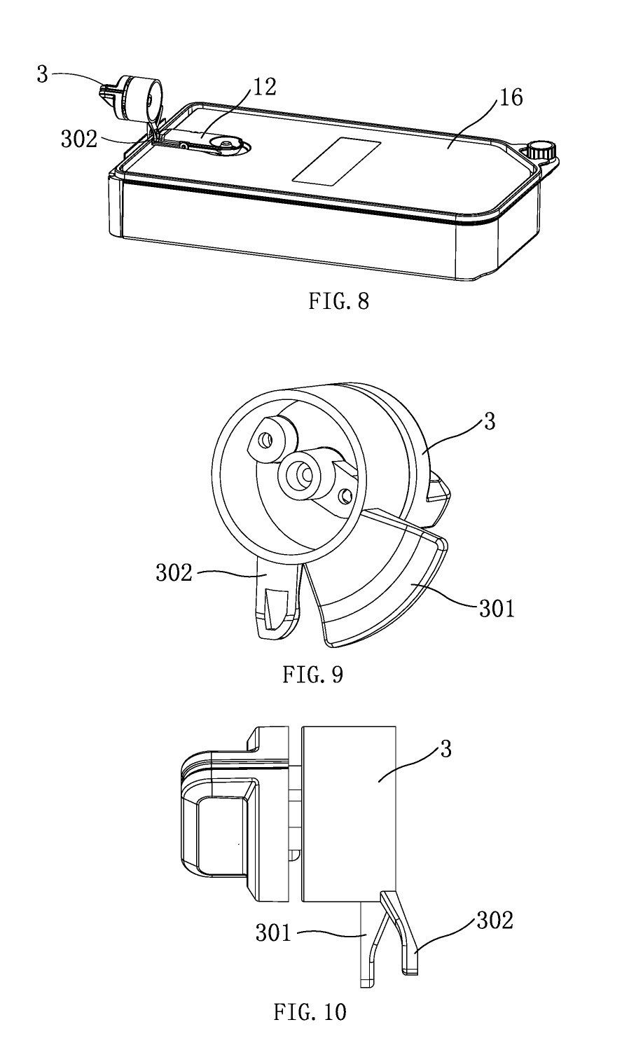

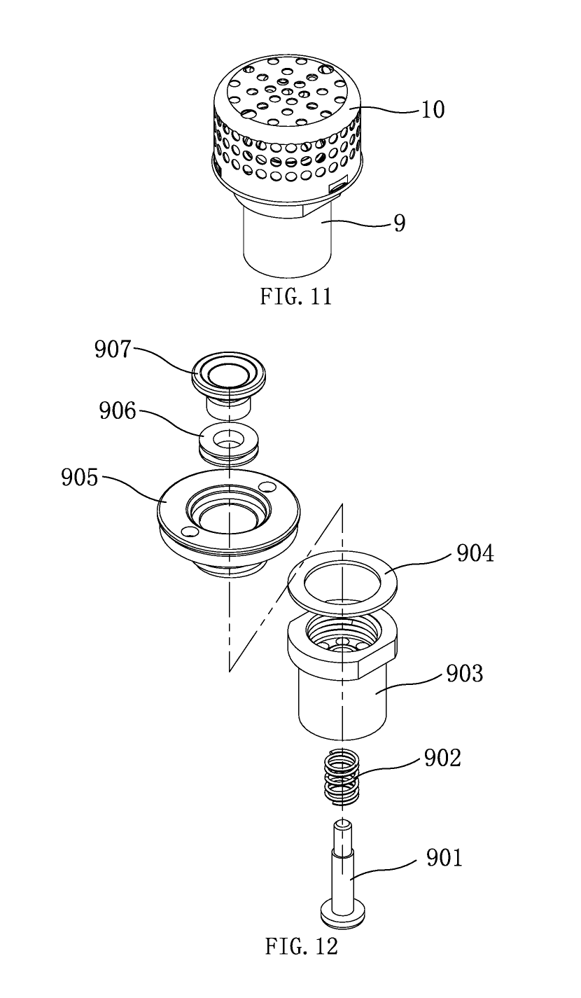

The structure and application of the present invention is further described in drawings. As shown in FIG. 1 through FIG. 12, the lid 6 of such deep fryer is provided with a transparent plate, breathable plate and handle, the inner pot 11 is provided in the housing 1, the base is provided in the housing at the bottom of inner pot, the oil receiver 16 is provided in the base; the knob 3 is provided at the upper part of oil receiver outlet in the base of housing, the cover plate 2 and limit slot are provided at the knob end of oil receiver, the cover plate is linked with the oil receiver as an entity; the other end angle is provided with the oil pouring opening that is symmetrical to the upper cover of the oil receiver, in which the oil pouring opening has a cover. The drain assembly 9 is mounted at the oil drain of inner pot, the oil drain assembly at the oil drain is provided with a filter screen 10, the heating tube is linked with the control box as an entity, the heating tube is L-shaped, when the control box is placed in the groove of housing, the heating tube is located at the inner bottom of inner pot. The control panel of the said control box 7 has an oil replacement indicator 701, the raised conductive grooves are symmetrically disposed at the heating tube end of the said control box, its one end is L-shaped outwardly, an arched spring piece is provided in the conductive groove at one L-shaped end, the insertion slot is provided in the box groove in the housing corresponding to the spring piece, and the conducting piece is provided in the insertion slot corresponding to the spring piece. Food basket of this deep fryer comprises big food basket 4 and small food baskets 5, both the big food basket and small food baskets are provided with handles, and the handle end of the inner rim of the big basket or small baskets is provided with the raised limit steel wire which is linked with the basket framework steel wire connecting to the handle as an entity, and two small food baskets are horizontally disposed in the big food basket side by side.

The specific structure at the oil drain assembly of such deep fryer: the rocker 12 is provided at the oil inlet opening of oil receiver, one end of rocker passes through the oil inlet of the plug 14 sealed oil receiver, its other end interacts with the knob, the pivot between two ends is mounted on the oil receiver which comprises a framework and cover; the rocker of oil inlet has an oil drain assembly on the upper part, the ejector rob 901 of the oil drain assembly interacts with the end of rocker which is provided with the oil filter opening 1201, the limit lug 301 and the rocker lug 302 are provided at the knob end of oil receiver in the housing, the limit lug is a big lug with an included angle of 60°, and the end angle of rocker lug that is connected to one end of limit lug has a guide curved edge; the limit lug 301 and the rocker lug 302 are provided at the knob end of oil receiver in the housing, the limit lug of knob is staggeringly and adjacently arranged to the rocker lug of knob in front and back position, the limit lug and the rocker lug of knob are located in the housing, the limit lug of knob is inserted into the limit slot of oil receiver, and the rocker lug of knob interacts with the rocker. The ejector rod of oil drain assembly is screw-shaped, one end of the ejector rob passes through the spring 902, the nut seat 903 sequentially to connect with the valve 907 in the nut 905, the valve is T-shaped and limited to the inner diameter of the nut orifice, the outer diameter of the valve is provided with a seal plug 906, the nut and the nut seat are connected and mounted at the oil drain opening of inner pot through the internal and external threads, and a sealing ring 904 is provided at the joint. The oil drain of inner pot has a bracket 15 which interacts with the oil receiver, the nut seat of oil drain assembly is fit into the bracket, and is V-shaped; the bottom of the knob end of the rocker has a compression spring 13 that is disposed in the compression spring slot of oil receiver.

When in use, the knob is turned to open, the oil receiver is placed into the housing base; when the knob is turned to close, the limit lug of knob is inserted into the limit slot of oil receiver, so that the oil receiver cannot be pulled out of the housing. Then the control box of such deep fryer is placed into the housing, oil is added into the inner pot, the temperature and time of control box is regulated, then the food is placed into the big or small food basket; in the end, big food basket or small food baskets are placed into the inner pot, so that food can be fried using oil. Upon the completion of frying, if the oil needs to be filtered and collected, the knob can be turned to oil draining; the rocker lug of knob interacts with the rocker driving the upward lifting of the ejector rod in oil drain assembly, the oil inlet opening of inner pot is opened, the waste oil in the inner pot flows into the oil receiver through the oil inlet opening, oil drain assembly and oil filter opening of the rocker. Release and turn the knob to open, withdraw the oil receiver in the housing when the rocker is reset through compression spring, the waste oil in the oil receiver can be readily poured out through the oil pouring opening, the oil receiver can be reused if reassembled into the housing by the said manner.

1. An oil filter deep fryer comprising a housing, lid, control box, heating tube, inner pot, oil receiver rand food basket, the said lid is provided with a transparent plate, breathable plate and handle, an inner pot is provided in the housing, a base is provided in the housing at the bottom of inner pot, an oil receiver is provided in the base, a rocker is provided at the oil inlet opening of oil receiver, one end of rocker passes through the oil inlet of the plug sealed oil receiver, its other end interacts with the knob, the pivot between two ends is mounted on the oil receiver which comprises a framework and cover; the said rocker of oil inlet has a drain assembly on the upper part, the ejector rob of drain assembly interacts with the end of rocker which is provided with the oil filter opening, the drain assembly is mounted at the oil drain of inner pot, the oil drain assembly at the oil drain is provided with a filter screen, the heating tube is linked with the control box as an entity, the heating tube is L-shaped, when the control box is placed in the groove of housing, the heating tube is located at the inner bottom of inner pot, wherein the said knob is provided at the upper part of oil receiver outlet in the base of housing, the cover plate and limit slot are provided at the knob end of oil receiver, the cover plate is linked with the oil receiver as an entity, the limit lug and the rocker lug are provided at the knob end of oil receiver in the housing, the limit lug of knob is staggeringly and adjacently arranged to the rocker lug of knob in front and back position, the limit lug and the rocker lug of knob are located in the housing, the limit lug of knob is inserted into the limit slot of oil receiver, and the rocker lug of knob interacts with the rocker.

2. An oil filter deep fryer according to claim 1 wherein the limit lug of the said knob is a big lug with an included angle of 60°, and the end angle of rocker lug that is connected to one end of limit lug has a guide curved edge.

3. An oil filter deep fryer according to claim 1 wherein the ejector rob of the said oil drain assembly is screw-shaped, one end of the ejector rob passes through the spring, the nut seat sequentially to connect with the valve in the nut, the valve is T-shaped and limited to the inner diameter of the nut orifice, the outer diameter of the valve is provided with a seal plug, the nut and the nut seat are connected and mounted at the oil drain opening of inner pot through the internal and external threads, and a sealing ring is provided at the joint.

4. An oil filter deep fryer according to claim 3 wherein the oil drain of inner pot has a bracket, which interacts with the oil receiver, the nut seat of oil drain assembly is fit into the bracket, and is V-shaped.

5. An oil filter deep fryer according to claim 1 wherein the oil drain assembly of the said rocker has a circular groove and the oil filter is provided at the knob end in the circular groove.

6. An oil filter deep fryer according to claim 1 wherein the bottom of the knob end of the said rocker has a compression spring that is disposed in the compression spring slot of oil receiver.

7. An oil filter deep fryer according to claim 1 wherein the other end angle is provided with the oil pouring opening that is symmetrical to the limit slot of the said oil receiver, in which the oil pouring opening has a cover.

8. An oil filter deep fryer according to claim 1 wherein the said food baskets comprise big food basket and small food baskets, both the big food basket and small food baskets are provided with handles, and the handle end of the inner diameter of the big basket or small baskets is provided with the raised limit steel wire which is linked with the basket framework steel wire connecting to the handle as an entity, and two small food baskets are horizontally disposed in the big food basket side by side.

9. An oil filter deep fryer according to claim 1 wherein the raised conductive grooves are symmetrically disposed at the heating tube end of the said control box, its one end is L-shaped outwardly, an arched spring piece is provided in the conductive groove at one L-shaped end, the insertion slot is provided in the box groove in the housing corresponding to the spring piece, and the conducting piece is provided in the insertion slot corresponding to the spring piece.

10. An oil filter deep fryer according to claim 1 wherein the control panel of the said control box has an oil replacement indicator.
